(19) United States
(12) Patent Application Publication
(10) Pub. No.: US 2008/0209241 A1
(43) Pub. Date: Aug. 28, 2008

(54) Power supply controller with multiple setting segments

(75) Inventor: Jim Huang, Tocheng City (TW)

Correspondence Address: TROXELL LAW OFFICE PLLC, SUITE 1404, 5205 LEESBURG PIKE, FALLS CHURCH, VA, 22041, US

(73) Assignee: Yea Yen Huang

(21) Appl. No.: 11/709,887

(22) Filed: Feb. 23, 2007

(51) Int. Cl. G06F 1/28; G06F 1/32

(52) U.S. Cl. 713/310; 713/324

(57) ABSTRACT

The present invention relates to a power supply controller with multiple setting segments, which comprises a display, a plurality of setting buttons, a standby indicator light and a PC connection terminal and is provided for allowing a user to easily conduct power supply control with respect to the multiple setting segments of the multiple outlets thereof by operating the setting buttons thereon directly or setting programs remotely with a computer.

### CROSS-REFERENCES TO RELATED APPLICATIONS

Not Applicable

### STATEMENT REGARDING FEDERALLY SPONSORED RESEARCH OR DEVELOPMENT

Not Applicable

### DESCRIPTION

### Technical Field

The present invention relates to a power supply controller with multiple setting segments, which comprises a display, a plurality of setting buttons, a standby indicator light and a PC connection terminal and is provided for allowing a user to easily conduct power supply control with respect to the multiple setting segments of the multiple outlets thereof by operating the setting buttons thereon directly or setting programs remotely with a computer.

### Background of the Invention

Much recent development of power supply controllers has been done by employing well-known electronic controls to supersede the mechanical controls previously used in earlier power supply controllers, and presenting multiple functions instead of the single function presented by earlier power supply controllers.

However, such a conventional power supply controller typically provides merely a single output terminal and is incapable of performing versatile functions such as temperature display, self-testing, timed alarm, remote control and multiple power-off protection.

According to the present invention, the disclosed power supply controller with multiple setting segments implements a particular circuit design and distinctive structure to provide the function of simultaneous power supply control with respect to the multiple setting segments of the multiple outlets thereof and has the following functions:

1. Temperature display, which ranges from −55° C.˜125° C.,

2. Electronic clock, showing the current year, month, date, hour, minute and second,

3. Timed alarm,

4. Multi-segmented on-off setting of power outlets, wherein each of the power outlets can be programmed with up to 8 on-off segments.

5. Uninterrupted operation of the electronic clock and operating state during power failure,

6. Automatic fault detection,

7. Over-voltage, over-current and over-temperature protections, and

8. Remote control conducted by means of a computer through the Internet.

By possessing the aforesaid functions, the disclosed subject matter achieves a desirable performance of power supply control and therefore accomplishes the functions of multiple power control as well as power supply protection. The structure and functions of the disclosed subject matter will be further illustrated in coordination with the attached drawings.

### SUMMARY OF THE INVENTION

The present invention provides a power supply controller with multiple setting segments having plural power outlets that can be programmed manually or through a computer network. The disclosed power supply controller comprises a display, a plurality of setting buttons, a standby indicator light and a PC connection terminal. Further, the disclosed subject matter can display temperature, setting information and provide over voltage, over current and over temperature protections. Moreover, the power supply controller with multiple setting segments of the present invention is characterized by the feature that allows a user to easily conduct power supply control with respect to the multiple setting segments of the multiple outlets thereof by operating the setting buttons thereon directly or setting programs remotely through a computer network.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a perspective view of the disclosed subject matter;

FIG. 2 is a front view of the disclosed subject matter;

FIG. 3 is a lateral view of the disclosed subject matter; and

FIG. 4 is an exploded view of the disclosed subject matter.

### DETAILED DESCRIPTION OF THE PREFERRED EMBODIMENT

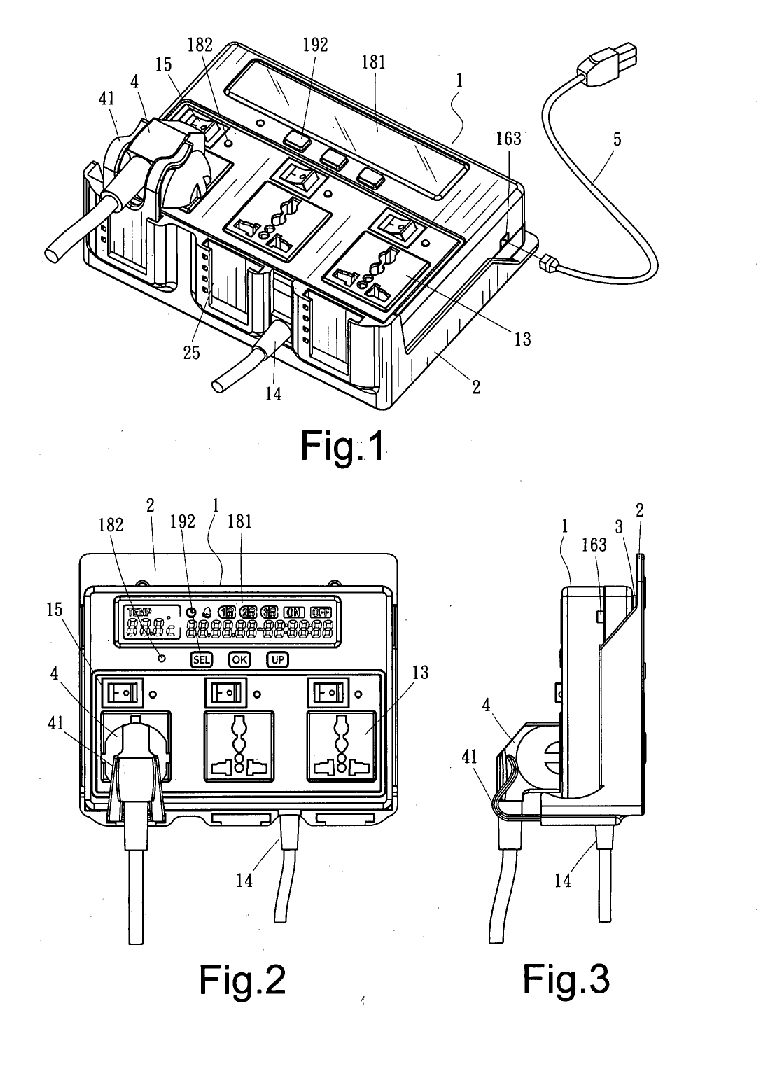

As shown in FIGS. 1 to 4, the disclosed power supply controller with multiple setting segments primarily comprises a controller body 1 and a socket 2 provided for being fastened to a wall and holding the controller body 1.

The socket 2 includes plural fixing holes 21 deposited on the inner wall thereof where the socket 2 can be fixed onto a wall, a carrying surface 22 for receiving the controller body 1 (and a user manual 3), two side railings 23 positioned at two opposite sides of the socket 2, and two flanges 24 provided respectively at the edges of the railings 23 for being engaged with two slide grooves 111 arranged on the sides of an upper housing 11 of the controller body 1.

Further, the socket 2 comprises a plurality of retaining recesses 25 which are situated at the outside of the carrying surface 22 and each of the retaining recesses 25 is for engaging a fixing tongue 41 of a connecting plug 4 to in turn retain the connecting plug 4 when the connecting plug 4 is inserted into one of a plurality of power outlets 13.

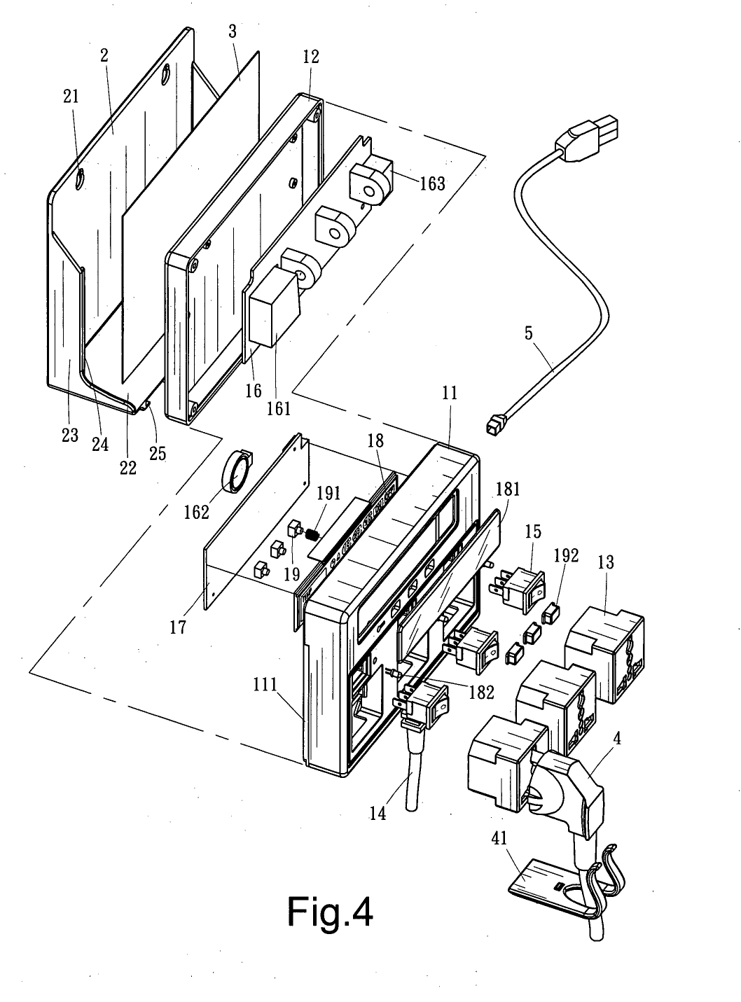

Referring to FIG. 4, it can be seen that the controller body 1 comprises the upper housing 11, a lower housing 12, the plural power outlets 13, a power input cable 14, a plurality of switches 15, a first circuit board 16, a second circuit board 17, an LCD display 18 and a plurality of setting buttons 19.

An IC 161 is settled on the foresaid first circuit board 16 loaded with all instruction and programs. The first circuit board 16 is connected to the second circuit board 17 and electrically connected with the power input cable 14, switches 15 and power outlets 13.

The LCD display 18, setting buttons 19 and standby indicator light 182 are fixed onto the second circuit board 17 wherein the LCD display 18 can be covered with a transparent protecting board 181 and each of the setting buttons 19 can have a spring 191 and a button 192 mounted on the spring 191 to be pressed for operation from the outside of the upper housing 111.

Additionally, a battery 162 is provided on the first circuit board 16 to supply power to the disclosed power supply controller for an internal timing function so that the controller is allowed to maintain operation according to a preset program without disturbance caused by an external power failure. Also, a USB connecting terminal 163 is settled on the first circuit board 16 for receiving an USB cable 5 to connect the power supply controller body 1 with a computer or Ethernet whereby the disclosed power supply controller can be remotely controlled through the computer network.

To sum up, the power supply controller with multiple setting segments of the present invention can be programmed directly by a user or remotely through a computer. The disclosed subject matter is capable of displaying temperature and setting information as well as a standby indicator, and providing over voltage and over current as well as over temperature protections. Moreover, the power supply controller with multiple setting segments of the present invention is characterized by the feature that a user can easily conduct power supply control with respect to the multiple setting segments of the multiple outlets thereof by operating the setting buttons thereon directly or setting programs remotely through a computer network.

To operate the disclosed power supply controller with multiple setting segments as shown in the figures, put power through the controller or press a reset button thereon to start a self-test function. At this time, the numerals 0 through 9 are circularly displayed in the manner that each of the numerals is displayed and erased four times.

Then press the “OK” button to terminate the self-test function and enter a buzzer setting mode. When “SET BEEB 0” and the symbol “OFF” appear on the LCD, press the “UP” button and the LCD displays “SET BEEB 1” and the symbol “ON”. Then continuously press the “UP” button to select from the “ON” or “OFF” states of the buzzer.

Afterward press the “OK” button to confirm the setting of the buzzer state and enter a clock set mode. The LCD now displays 06:01:01-12:00:00 which respectively correspond to the setting values for the year, month, date, hour, minute, and second, and the numeral corresponding to the setting value for the year is now blinking. Press the “UP” button to increment the blinking numeral by 1 each time and press and hold the “UP” button to continuously increment the blinking numeral by 1. Press the “SEL” button to make the next numeral blink. Similarly, the setting of the values for the month, date, hour, minute, and second can be accomplished by alternatively pressing the “UP” and “SEL” buttons.

Press the “OK” button to confirm the settings for the present time and enter a clock and alarm set mode. The LCD now is displaying 00:00:00 which respectively correspond to the setting values for the hour, minute second and the symbol “OFF”. Press the “UP” button to switch on or off the timed alarm and it can be seen that the symbol “ON” and the symbol “OFF” appear on the display alternatively. Press the “OK” button when the symbol “OFF” is displayed to finish the clock and alarm set mode and enter a fifth step. Alternatively, press the “OK” button when the symbol “ON” is displayed to switch on the alarm and cause the numeral corresponding to the setting value for the hour to blink. Press the “UP” button to increment the blinking numeral by 1 each time and press and hold the “UP” button to continuously increment the blinking numeral by 1. Press the “SEL” button to make the next numeral blink. Similarly, settings of values for the present hour minute and second can be accomplished by alternatively pressing the “UP” and “SEL” buttons.

Press the “OK” button to confirm the setting of the alarm, and the disclosed power supply controller enters an operating mode. The LCD now displays the electronic clock. Press the “OK” or “SEL” button at this point to enter a power outlet setting mode. The LCD displays the switch-on time for the first power outlet as 06:01:01-00:00:00 which respectively correspond to the setting values for the year, month, date, hour, minute, and second. Continuously press the “SEL” button to switch among outlets 1, 2, 3 and exit, and press the “UP” button to switch among switch-on time segments 1 through 8 of the desired power outlet. When the switch-on time segment of the power outlet to be set is displayed, press the “OK” button to enter a setting mode and modify the switch-on time thereof. The numeral corresponding to the setting value for the year is now blinking. Press the “UP” button to increment the blinking numeral by 1 each time and press and hold the “UP” button to continuously increment the blinking numeral by 1. Then press the “SEL” button to make the next numeral blink.

When the numeral corresponding to the setting value for the second is blinking, press the “SEL” button to switch the display between the start time and the end time of the preset switch-on time segment wherein the start time is displayed with an “ON” symbol and the end time is displayed with an “OFF” symbol. Press the “OK” button in said setting mode to confirm and save the settings of the start time and the end time of the preset switch-on time segment. Then the LCD automatically displays the start time of the next switch-on time segment, and press the “OK” button to enter a setting mode for the presently displayed start time. Thus, settings of all the switch-on time segments 1 through 8 of the power outlets 1 through 3 can be accomplished by repeating the aforesaid operating procedures. The display can automatically return to the electronic clock when there is no button being pressed in a continuous period of 30 seconds. It is to be noted that when setting the switch-on time segments, the start time of each segment has to be later than the end time of the successively earlier segment; otherwise the settings shall become invalid. Press the “OK” button and the settings for the currently programmed switch-on time segment are displayed again on the LCD

Because a battery is provided in the disclosed power supply controller, the electronic clock and operating state thereof are protected from being disturbed by a power failure. The power outlets have the functions of over current, over temperature and power-failure protections. Therefore, when over current, over temperature and power-failure occur to the power outlets, the affected power outlets are automatically switched off, and symbols representing the affected power outlets blink on the LCD. When said over current, over temperature and power-failure are relieved, the power outlets are not electrified automatically. To restart the controller, press the “UP” button and the LCD displays the states of the power outlets as they were before the problem occurred wherein “0” represents “off” while “1” represents “on”. Then press the “OK” button and the power outlets are recovered to the operating states of on or off respectively as of before the problem occurred. The display automatically turns to the electronic clock when there is no button being pressed in a continuous period of 30 seconds

Through the setting steps described previously, the power supply controller with multiple setting segments of the present invention can be programmed with power supply control with respect to the multiple setting segments of the multiple outlets thereof and conduct power supply control accordingly.

Although a particular embodiment of the invention has been described in detail for purposes of illustration, it will be understood by one of ordinary skill in the art that numerous variations will be possible to the disclosed embodiments without going outside the scope of the invention as disclosed in the claims.

What is claimed is:

1. A power supply controller with multiple setting segments which primarily comprises:
a controller body comprising an upper housing, a lower housing, a plurality of power outlets, a power input cable, a plurality of switches, a first circuit board, a second circuit board, an LCD display and a plurality of setting buttons, wherein the foresaid first circuit board comprises an IC which is loaded with all instructions and programs and the foresaid first circuit board is connected to the second circuit board and electrically connected with the power input cable, switches and power outlets; the LCD display, setting buttons and standby indicator light are fixed onto the second circuit board wherein the LCD display can be covered with a transparent protecting board and each of the setting buttons can have a spring and a button mounted on the spring to be pressed for operation from the outside of the upper housing; and
a socket, including plural fixing holes deposited on the inner wall thereof whereby the socket can be fixed on a wall, a carrying surface for receiving the controller body;
wherein the power supply controller is characterized by the features of displaying temperature, setting information and providing over-voltage, over-current and over-temperature protections and allowing a user to easily conduct power supply control with respect to multiple setting segments of the multiple outlets thereof by operating the setting buttons.

2. The power supply controller of claim 1, wherein a battery is provided on the first circuit board in the controller body to supply power to the power supply controller for supplying power to an internal timing function thereof so that the controller is allowed to maintain operation according to preset programs free from disturbance caused by an external power failure.

3. The power supply controller of claim 1, wherein a USB connecting terminal is settled on the first circuit board in the controller body for receiving a USB cable to connect the power supply controller body with a computer or Ethernet whereby the power supply controller can be remotely programmed through the computer network.

4. The power supply controller of claim 1, wherein a plurality of retaining recesses are situated at the outside of the carrying surface and each of the retaining recesses is for engaging a fixing pin of a connecting plug to in turn retain the connecting plug when the connecting plug is inserted into one of a plurality of power outlets.
